(19) United States
(12) Patent Application Publication
(10) Pub. No.: US 2013/0080047 A1
(43) Pub. Date: Mar. 28, 2013

(54) VEHICULAR DRIVING ASSISTANCE APPARATUS

(71) Applicants: Tomokazu KOBAYASHI, Kariya-city (JP); Katsuhiko MUTOH, Toyota-city (JP)

(72) Inventors: Tomokazu KOBAYASHI, Kariya-city (JP); Katsuhiko MUTOH, Toyota-city (JP)

(73) Assignee: DENSO CORPORATION, Kariya-city (JP)

(21) Appl. No.: 13/241,833

(22) Filed: Sep. 23, 2011

(30) Foreign Application Priority Data
Sep. 23, 2011 (JP) 2010-224167

(51) Int. Cl. G01C 21/26

(52) U.S. Cl. 701/409

(57) ABSTRACT

A present position candidate in a reverse run state of a vehicle and a present position candidate in a normal run state of the vehicle are clarified to be coexisting. When a collision buffer object peculiar to a branch point of a highway is detected by an image recognition from a vehicle front image captured by a front camera of the vehicle, the vehicle is determined to be in the reverse run state, thereby enabling a more accurate determination of the reverse run in the highway.

### CROSS REFERENCE TO RELATED APPLICATION

The present application is based on and incorporates herein by reference Japanese Patent Application No. 2010-224167 filed on Oct. 1, 2010.

### FIELD OF THE INVENTION

The present invention relates to a vehicular driving assistance apparatus to prevent a reverse run of a vehicle.

### BACKGROUND OF THE INVENTION

[Patent document 1] JP-2007-139531 A

[Patent document 2] JP-2009-193507 A

There is conventionally proposed a technology to prevent a reverse run of a vehicle on a highway,

1. Prior Art 1

For example, Patent document 1 discloses a technology as follows. A present position and heading direction of a subject vehicle is measured by use of a GPS (Global Positioning System). Such measurement enables a detection of a reverse run of the subject vehicle in a freeway that prohibits a reverse run. Then warning is outputted or notified. Here, the above technology is called Prior Art 1.

In this regard, however, there may be occurring an error of the measurement using the GPS in the present position of the subject vehicle. In this case, Prior Art 1 may mistakenly detect that the subject vehicle is running reversely even when running normally in an adjacent road, executing a wrong warning. This is a problem of Prior Art 1.

2. Prior Art 2

To that end, the following technology (called Prior Art 2) is proposed as a countermeasure to solve such a problem. In Prior Art 2, a predictable error range is calculated in respect of a measured present position of a subject vehicle. When several roads are included in the predictable error range, a candidate (i.e., present position candidate) of the present position of the subject vehicle is designated on the several roads. In cases where there is existing a present position candidate corresponding to a normal run, the determination of the reverse run is not made even if there is simultaneously existing a present position candidate corresponding to a reverse run.

3. Prior Art 3

Patent document 2 discloses a technology (called Prior Art 3) as follows. A stationary object in vicinity of a join road of a highway is extracted from each image data which is captured by an image capture device. The determination of a reverse run of a subject vehicle is made based on a displacement pattern of the stationary object changing the position on the image data according to the travel of the subject vehicle. In detail, in Prior Art 3, images are captured serially in a highway when the subject vehicle is joining or merging into a main road from a join road From the captured images, a rotation pattern of an external line of a traffic lane is extracted. When the extracted rotation pattern has a counter clockwise direction and an angle of more than a predetermined value, it is determined that the subject vehicle started the reverse run on the highway.

Returning to Prior Art 2. Suppose the case where there are roads existing in parallel in vicinity of the measured present position of the subject vehicle. In such a case, even though the subject vehicle is actually running reversely or backward, the reverse run is not determined when the present position candidate corresponding to a normal run is existing. Thus, the reverse run is not determined at all in the case that the present position candidate corresponding to the normal run is existing, posing a problem in Prior Art 2.

Further, returning to Prior Art 3. The rotation pattern or rotation angle of the external line of the traffic lane in the images captured serially in a service area of the highway is identical in between the case of exiting from an exit of the service area normally and the case of exiting from an entrance of the service area mistakenly. Thus, the reverse run is not determined when mistakenly exiting from an entrance of the service area of the highway, posing a problem.

### SUMMARY OF THE INVENTION

The present invention is made in view of the above problem. It is an object of the present invention to provide a vehicular driving assistance apparatus to enable more accurate determination of a reverse run of a vehicle in a highway.

To achieve the above object, according to an aspect of the present invention, a vehicular driving assistance apparatus mounted in a vehicle is provided as follows. A position and direction detection device is included to detect a present position and a heading direction of the vehicle serially. A map data storage device is included to store map data including road data containing data on one-way traffic attribute. A candidate extraction section is included to extract a present position candidate of the vehicle on an on-map road by matching a travel track of the vehicle on the on-map road based on a present position and a heading direction of the vehicle detected by the position and direction detection device and the map data stored in the map data storage device. A position specification section is included to specify a present position of the vehicle on an on-map road based on a present position candidate extracted by the candidate extraction section. An image capture device is included to capture serially an image in a heading direction of the vehicle. An image recognition section is included to detect from an image captured by the image capture device with image recognition a structural object peculiar to a branch point that is contained together with a joint point in a highway. A reverse run candidate clarification section is included to clarify whether a present position candidate of the vehicle is a revere run candidate that corresponds to a reverse run state of the vehicle or a normal run candidate that does not correspond to a reverse run state of the vehicle based on (i) a present position candidate extracted by the candidate extraction section, (ii) a heading direction of the vehicle detected by the position and direction detection device, and (iii) the road data containing the data on one-way traffic attribute. A reverse run determination section is included to determine whether the vehicle is in a reverse run state based on a clarification result by the reverse run candidate clarification section and a detection result by the image recognition section in cases that the candidate extraction section extracts a plurality of present position candidates. Herein, the reverse run determination section determines that the vehicle is in the reverse run state in cases that (i) a reverse run candidate of the vehicle that is clarified to correspond to the reverse run state of the vehicle and a normal run candidate of the vehicle clarified not to correspond to the reverse run state of the vehicle coexist within the plurality of present position candidates extracted by the candidate extraction section and (ii) the structural object peculiar to the branch point is detected by the image recognition section. In contrast, the reverse run determination section does not determine that the vehicle is in the reverse run state in cases that (i) the reverse run candidate and the normal run candidate coexist within the plurality of present position candidates extracted by the candidate extraction section, and (ii) the structural object peculiar to the branch point is not detected by the image recognition section.

In a highway, a main road has a branch point and a join point, A branch road (i.e., exit road from a highway, or a highway exit road, further a service area entrance road) branches from the main road at the branch point towards a post-branch destination such as a service area; a join road (i.e., an entrance road to a highway, or a highway entrance road, further, a service area exit road) joins into the main road at the join point from a prior-join departure point such as a service area. If a vehicle mistakenly runs the branch road reversely from the service area in a reverse run state instead of normally running the join road in a normal run state, the vehicle may reach the main road at the branch point under the reverse run state. There is arranged a structural object peculiar to a branch point, for instance, as a collision buffer, in a highway. When running a join road to join a main road, the vehicle does not see a structural object peculiar to a branch point. In contrast, if running a branch road in a reverse run state to a main road, the vehicle sees the structural object peculiar to the branch point, Thus, the reference to whether to detect a structural object peculiar to a branch point can reinforce a determination as to whether a vehicle is in a reverse run state or not.

There may be a case that a present position candidate clarified to be in a reverse run state and a present position candidate clarified to be in a normal run state coexist. In such a case where it is not easy to determine a reverse run state, the configuration of the above aspect enables an accurate determination of a reverse run in a highway. That is, the reverse run state is determined when the structural object peculiar to a branch point is detected.

In contrast, the reverse run state is not determined when the structural object peculiar to a branch point is not detected.

Further, suppose the case where a vehicle runs reversely a branch road from a service area or parking lot to a main road of the highway in a reverse run state. In this case, the vehicle naturally sees a structural object peculiar to the branch point in the main road of the highway. Thus, based on the detection of the structural object peculiar to the branch point, an accurate determination of the reverse run state can be made.

### BRIEF DESCRIPTION OF THE DRAWINGS

The above and other objects, features, and advantages of the present invention will become more apparent from the following detailed description made with reference to the accompanying drawings. In the drawings:

FIG. 1 is a diagram illustrating a configuration of a reverse run detection apparatus according to an embodiment of the present invention;

FIG. 2 is a block diagram illustrating a configuration of a navigation apparatus;

FIG. 3 is a functional block diagram illustrating a control circuit of the navigation apparatus;

FIGS. 4A, 4B are diagrams illustrating examples of collision buffer objects;

FIG. 5 is a flowchart diagram illustrating a reverse run determination process when several present position candidates are detected;

FIG. 6 is a flowchart diagram illustrating another reverse run determination process when a single present position candidate is detected; and

FIGS. 7 to 9 are diagrams illustrating operations in the configuration of the present embodiment.

### DETAILED DESCRIPTION OF THE PREFERRED EMBODIMENTS

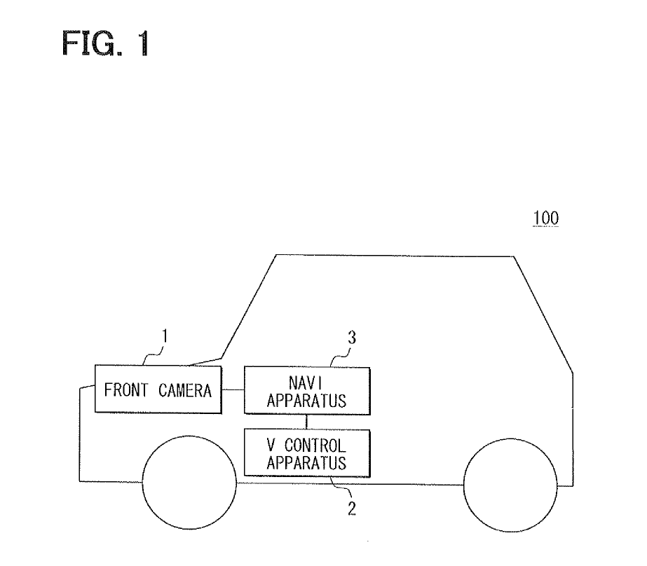

An embodiment of the present invention is explained with reference to drawings. FIG. 1 illustrates an overall configuration of a reverse run detection apparatus 100 according to an embodiment of the present invention. The reverse run detection apparatus 100 illustrated in FIG. 1 is mounted in a subject vehicle, and contains a front camera 1, a vehicle control apparatus 2, and a navigation apparatus 3. The reverse run detection apparatus 100 may be also referred to as a vehicular driving assistance apparatus.

The front camera 1 is mounted in a front portion of the subject vehicle, and captures an image of a region covered with a predetermined angle in a heading direction of the subject vehicle. The front camera 1 may be also referred to as an image capture device. For example, the front camera 1 uses a CCD camera. Capture image data ahead of the subject vehicle captured by the front camera 1 is transmitted to the control circuit 44 of the navigation apparatus 3. The image captured by the front camera 1 may be also referred to as a vehicle front image.

The vehicle control apparatus 2 is to control a travel or motion of the subject vehicle compulsorily. For example, the vehicle control apparatus 2 includes a throttle actuator for controlling a throttle opening and a brake actuator for controlling a braking pressure.

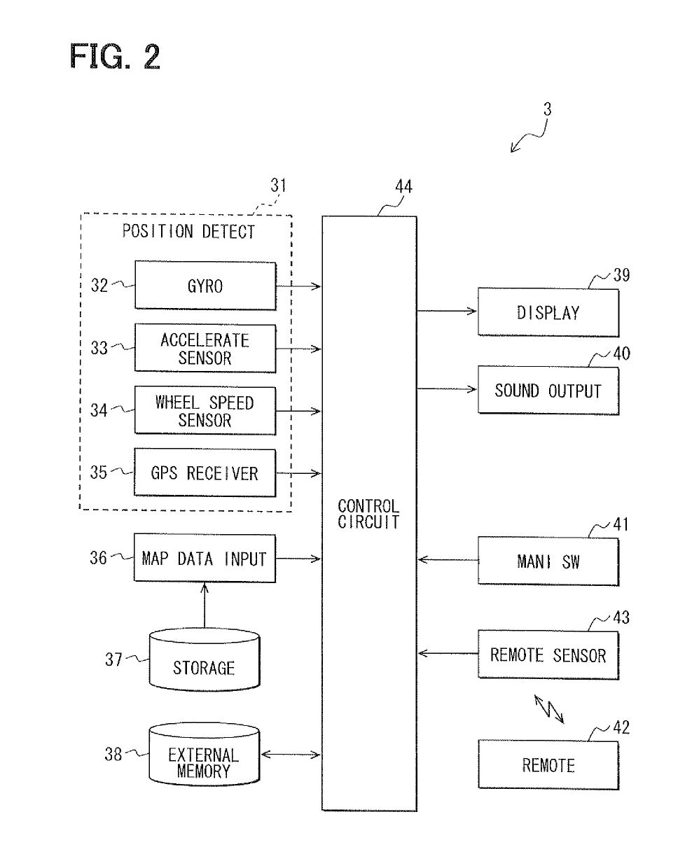

The navigation apparatus 3 has a navigation function, such as a route retrieval and a route guidance. The following explains an outline configuration of the navigation apparatus 3 with reference to FIG. 2. FIG. 2 is a block diagram illustrating a configuration of the navigation apparatus 3. As illustrated in FIG. 2, the navigation apparatus 3 includes the following: a position detection device 31, a map data input device 36, a storage media 37, an external memory 38, a display device 39, a sound output device 40, a manipulation switch group 41, a remote control terminal 42 (i.e., a remote), a remote control sensor 43, and the control circuit 44.

The position detection device 31 includes a gyroscope 32 which detects an angular velocity around a perpendicular direction of the subject vehicle, an acceleration sensor 33 which detects an acceleration of the subject vehicle, a wheel speed sensor 34 which detects a velocity or speed of the subject vehicle from a rotation speed of each rotating wheel, and a GPS receiver 35 for GPS (Global Positioning System) which detects a present position of the subject vehicle based on electric waves from artificial satellites. The position detection device 31 detects a present position and a heading direction of the subject vehicle periodically. The position detection device 31 may be referred to as a position and direction detection device or means.

The individual sensors or the like 32 to 35 have different types of detection errors different from each other; therefore, they are used to complement each other. In addition, part of the sensors or the like may be used depending on the required detection accuracy, or another sensor or the like such as a geomagnetic sensor or a rotation sensor of the steering may be used.

The navigation apparatus 3 specifies a present position and a heading direction of the subject vehicle periodically with a hybrid navigation which combines an autonomous navigation and an electric wave navigation. The travel track of the subject vehicle is obtained from the specified present position and heading direction is collated with road data mentioned later. The travel track of the subject vehicle is matched on on-map roads, which are roads on a map. An on-map road having a highest correlation with the travel track is estimated to be a road or on-map road the subject vehicle runs. The present position on the on-map road of the subject vehicle (i.e., a position which is displayed as a vehicle position on the on-map road) is specified.

The autonomous navigation is a method of estimating a present position of the subject vehicle from the measured value of the direction sensor such as the gyroscope 32 and the measured value of the acceleration sensor 33 or wheel speed sensor 34. In addition, the electric wave navigation is a method of estimating a present position by measuring a coordinate (latitude and longitude) of the subject vehicle with the GPS receiver 35 based on the electric waves from several artificial satellites.

The map data input device 36 contains a storage media 37 and is used for inputting the various data containing map data and landmark data stored in the storage media 37. The map data include road data having node data and link data for indicating roads. Nodes are points at which roads cross, branch, or join; links are segments between nodes. A road is constituted by connecting links. The link data relative to each link include a unique number (link ID) for specifying the link, a link length for indicating the length of the link, start and end node coordinates (latitudes and longitudes), a road name, a road class, a one-way traffic attribute, a road width, the number of lanes, presence/absence of dedicated lanes for right/left turn and the number thereof, and a speed limit. Therefore, the storage media 37 may be referred to as a map data storage device or means.

The node data relative to each node include a unique number (node ID) for specifying the node, node coordinates, a node name, connection link IDs for indicating links connected to the node, and an intersection class. The node data include data of the node classes such as a branch point and a join point on a highway.

Moreover, the above storage media 37 includes data on classes, names, and addresses of various facilities, which are used to designate destinations in route retrieval, etc. The above storage media 37 may be a CD-ROM, DVD-ROM, memory card, HDD, or the like.

The external memory 38 is a rewritable memory with a large data volume such as a hard disk drive (HOD). The external memory 38 stores data, which need to be inerasable even if power supply is turned off, or is used for copying frequently used data from the map data input device 36.

The display device 39 displays a map, a destination selection window, a reverse run warning window, and is able to display images in full colors using such as a liquid crystal display, an organic electroluminescence display, or a plasma display. The sound output device 40 includes a speaker and outputs a guidance sound in the route guidance and a reverse run warning sound based on instructions by the control circuit 44.

For example, the manipulation switch group 41 includes a mechanical switch or touch-sensitive switch which is integrated with the display device 39. According to a switch manipulation, an operation instruction for each of various functions is issued to the control circuit 44. In addition, the manipulation switch group 41 includes a switch for setting a departure point and a destination. By manipulating the switch, the user can designate the departure point and destination from points previously registered, facility names, telephone numbers, addresses, etc.

The remote control 42 has multiple manipulation switches (not shown) for inputting various command signals into the control circuit 44 via the remote control sensor 43 by switch manipulation to execute the same function as the manipulation switch group 41 to the control circuit 44.

The control circuit 44 includes mainly a well-known microcomputer which contains a CPU, a ROM, a RAM, and a backup RAM. The control circuit 44 executes processes as a navigation function such as a route guidance process or a process relative to a reverse run detection based on a variety of information inputted from the position detection device 31, the map data input device 36, the manipulation switch group 41, the external memory 38, and the remote control sensor 43.

For instance, the route guidance process operates as follows. When a departure point and a destination are inputted via the manipulation switch group 41 or the remote control 42, an optimal travel route to arrive at the destination is retrieved so as to satisfy a predetermined condition such as a distance priority or a time priority using the well-known Dijkstra method. The display device 39 is caused to display the retrieved travel route in superimposition on the displayed map to perform a route guidance. The sound output device 40 is caused to output a guidance speech to navigate along the retrieved route up to the destination. The departure point may be a present position of the subject vehicle inputted from the position detection device 31. The process relevant to the detection of the reverse run or driving backward is explained later in detail.

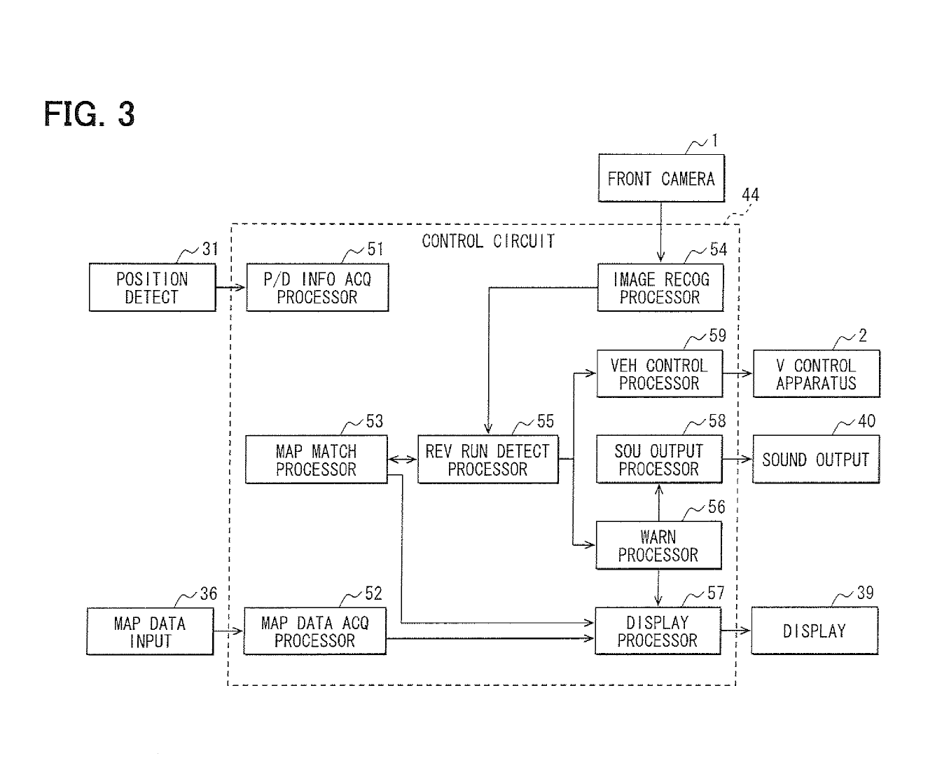

The following explains an outline configuration of the control circuit 44 with reference to FIG. 3. FIG. 3 is a functional block diagram illustrating the control circuit 44 of the navigation apparatus 3. It is noted that for convenience the explanation is omitted with respect to the processes other than the detection of the reverse run. As illustrated in FIG. 3, the control circuit 44 includes the following: a position and direction information acquisition processor 51, a map data acquisition processor 52, a map matching processor 53, an image recognition processor 54, a reverse run detection processor 55, a warning processor 56, a display processor 57, a sound output processor 58, and a vehicle control processor 59.

The position and direction information acquisition processor 51 acquires information on a present position and a heading direction of the subject vehicle which are detected by the position detection device 31. The map data acquisition processor 52 acquires the various data such as the map data which are inputted from the map data input device 36. The map data acquisition processor 52 inputs the map data inputted from the map data input device 36 into the map matching processor 53, or inputs the various data such as the map data or landmark data inputted from the map data input device 36 into the display processor 57.

The map matching processor 53 makes the travel track of the subject vehicle match on an on-map road (i.e., a road on a map or map data) based on (i) the information on the present position and the heading direction of the subject vehicle acquired in the position and direction information acquisition processor 51 and (ii) the map data acquired in the map data acquisition processor 52. As a result of matching, a present position candidate is extracted as a position that is nearest to the present position detected by the position detection device 31 on the on-map road matched with the matching accuracy more than a predetermined value. Therefore, the map matching processor 53 may be also referred to as a candidate extraction section or means. It is noted that above-mentioned predetermined value may be designated as needed.

The matching accuracy is an index which indicates the probability of matching, i.e., how probable the matched on-map road is as a road under travel of the subject vehicle. The matching accuracy may be calculated with the well-known method.

That is, it may be calculated by the map matching processor 53 based on the anomalies of the sensors 32 to 35 of the subject vehicle (failure due to disconnection and short-circuiting), the states of the various sensors of the subject vehicle (GPS reception state), the shape correlation and direction deviation in the matching, and the number of matching candidates. Therefore, the map matching processor 53 may be also referred to as a matching accuracy calculation section or means.

For example, when the present position of the subject vehicle detected by the position detection device 31 does not exist on an on-map road, the matching accuracy is calculated to be lowest. In addition, the matching accuracy is calculated to be lower, when the road immediately after passing through a branch road with a narrow angle or the inbound lane and the outbound lane are not determined, or when parallel roads are present nearby. On the contrary, the matching accuracy is calculated to be higher, when the inbound lane and the outbound lane are determined or when the present position is on a single on-map road in a suburb or mountainous area, for instance.

The above-mentioned extraction of the present position candidate is made each time the information on the present position and heading direction of the subject vehicle is periodically detected by the position detection device 31.

The map matching processor 53 outputs the extracted present position candidate to the reverse run detection processor 55. For example, when several present position candidates coexist, the several present position candidates are outputted to the reverse run detection processor 55. After outputting each extracted present position candidate to the reverse run detection processor 55, the map matching processor 53 estimates the road or on-map road having the highest correlation (i.e., the road having the highest matching accuracy) as a road the subject vehicle runs, and specifies the present position candidate as a position which is displayed as a vehicle position on the on-map road. Therefore, the map matching processor 53 may be also referred to as a position specification section or means.

Further, the map matching processor 53 may specify the position which is displayed as a vehicle position upon receiving a determination result of the reverse run detection processor 55. Such a configuration will be mentioned later.

The image recognition processor 54 detects a collision buffer object peculiar to a branch point on a highway using an image recognition based on the capture image data of the vehicle front images serially captured by the front camera 1. Thus, the image recognition processor 54 may be referred to as an image recognition section or means. Here, the highway includes a national expressway, a city expressway, and a freeway dedicated for automobiles.

In addition, the image recognition processor 54 records on a memory the capture image data for a fixed time or duration of the vehicle front images captured in the past with the front camera 1. In addition, the image recognition processor 54 continues recording newly the capture image data of the vehicle front images captured with the front camera 1 while erasing the data, which becomes older, one by one.

The detection of the collision buffer object may be made by a known image recognition to recognize an object in the image using a dictionary for image recognition. In this case, the used dictionary may be one having undergone a mechanical learning about a collision buffer object (a cascade of boosted classifiers based on Haar-like features in rectangular luminance difference).

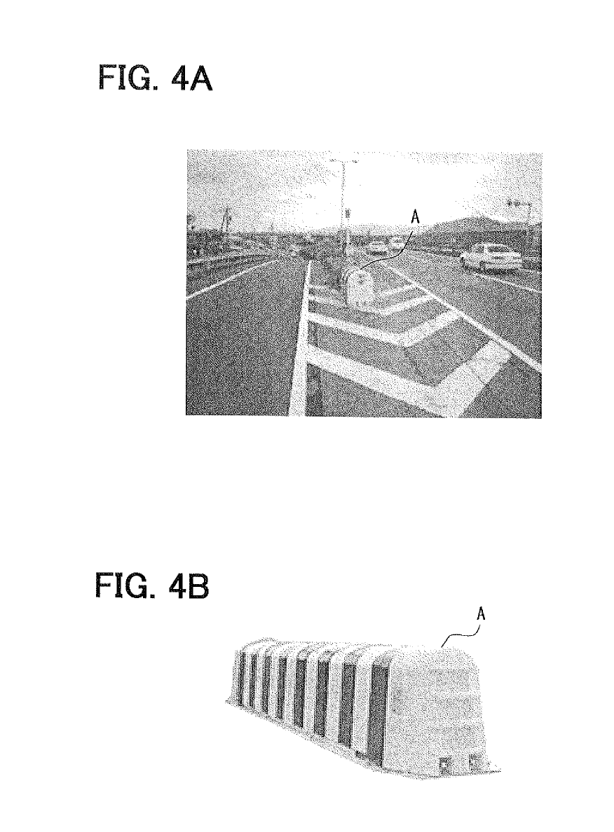

An example of the collision buffer object A is illustrated in FIGS. 4A, 4B.

The collision buffer object is provided in a branch point and is arranged in front of a structure such as a wall for branching the road or attached into the structure as illustrated in FIG. 4A. It is used for the purpose of avoiding the collision to the above structure, or reducing the impact at the time of the collision.

The collision buffer object is provided with a coloring pattern which attracts drivers' attention such as a coloring striped pattern of yellow and black, for example (refer to FIG. 4B). Therefore, the detection of the collision buffer object can be made accurately by the image recognition processor 54 according to the coloring pattern. In addition, the coloring pattern can be recognized or confirmed not only in the case of passing by the branch point by normal run but also in the case of passing by the branch point by reverse run from the destination point after branch such as a service area. Therefore, the collision buffer object is detectable from the vehicle front image captured by the front camera 1 at the time of the reverse run from the destination point after the branch in the image recognition of the image recognition processor 54.

The reverse run detection processor 55 executes a reverse run candidate clarification process to clarify whether the subject vehicle is running a present position candidate corresponds to a reverse run state, based on (i) the present position candidate(s) extracted by the map matching processor 53, (ii) the heading direction of the subject vehicle acquired in the position and direction information acquisition processor 51; (iii) the data on one-way traffic attribute of the map data acquired in the map data acquisition processor 52. Thus, the reverse run detection processor 55 may be referred to as a reverse run candidate clarification section or means.

In addition, the reverse run detection processor 55 determines whether the subject vehicle is in a reverse run state based on the clarification result in the reverse run candidate clarification process, and the detection result in the image recognition processor 54. The determination as to whether the subject vehicle is in a reverse run is explained in detail later. Thus, the reverse run detection processor 55 may be also referred to as a reverse run determination section or means.

The warning processor 56 transmits an instruction signal to cause the display processor 57 to warn about the reverse run when the detection result indicating the reverse run state is outputted from the reverse run detection processor 55.

The display processor 57 warns of the reverse run by displaying a warning window of reverse run, etc. in the display device 39 when the instruction signal for warning of the reverse run is sent from the warning processor 56. One example is displaying a message “please confirm the traveling direction.”

The display processor 57 causes the display device 39 to display a mark which indicates the present position of the subject vehicle on the point according to the information on the position based on the various data such as the map data and landmark data inputted from the map data acquisition processor 52 when the information on the position, which is displayed as a vehicle position and specified by the map matching processor 53, is inputted.

The sound output processor 57 warns of the reverse run by causing the sound output device 40 to output a warning sound of reverse run, etc. when the instruction signal for warning of the reverse run is sent from the warning processor 56. One example is sounding a message “please confirm the traveling direction.”

The vehicle control processor 59 transmits an instruction signal to the vehicle control apparatus 2, for example, to compulsorily decrease the throttle opening or compulsorily increase the braking pressure, thereby decelerating the subject vehicle compulsorily when the detection result indicating the reverse run state is outputted from the reverse run detection processor 55. The vehicle control processor 59 may be configured to transmit an instruction signal to the vehicle control apparatus 2 to decelerate the subject vehicle, for example, when the reverse run state is continued even after a predetermined elapsed time since the warning of the reverse run is made by the display processor 57 or the sound output processor 58. The predetermined elapsed time may be designated as needed.

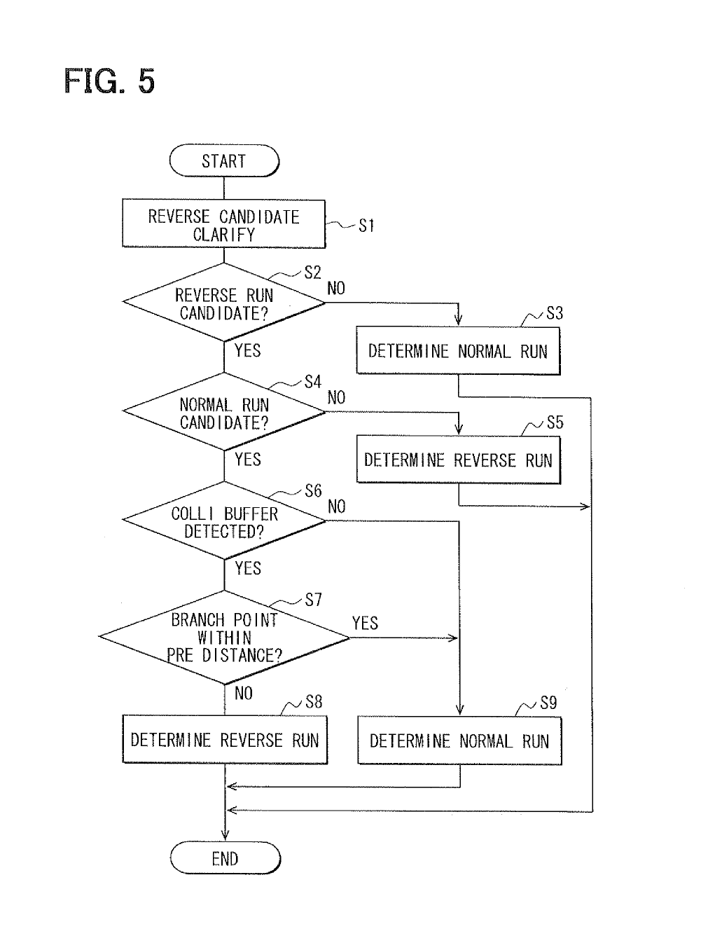

Next, with reference to FIG. 5, in the case that the map matching processor 53 extracts several present position candidates, the process relevant to the determination as to whether the subject vehicle is in a reverse run in the reverse run detection processor 55 will be explained. It is noted that the present process is started when the several present position candidates extracted by the map matching processor 53 are inputted into the reverse run detection processor 55.

It is further noted that a flowchart or the processing of the flowchart in the present application includes sections (also referred to as steps), which are represented, for instance, as S1. Further, each section can be divided into several sub-sections while several sections can be combined into a single section. Furthermore, each of thus configured sections can be referred to as a device, means, module, or processor and achieved not only as a software section in combination with a hardware device but also as a hardware section.

At S1, a reverse run candidate clarification process is executed with respect to the inputted several present position candidates. Then the processing proceeds to S2. When it is clarified that a present position candidate corresponding to a reverse run state (also referred to as a reverse run candidate) is present among the several present position candidates (S2: YES), the processing then proceeds to S4. In contrast, when it is not clarified that any reverse run candidate is present among the several present position candidates (S2: NO), the processing proceeds to S3.

At S3, it is determined that the subject vehicle is in a normal run, and the detection result indicating the normal run state is outputted, then ending the present process. Further, at S3, based on the matching accuracy calculated by the map matching processor 53, the information on the normal run candidate having the highest matching accuracy may be transmitted to the map matching processor 53 among the normal run candidates, thereby specifying the position of the normal run candidate as a position which is displayed as a vehicle position on a map.

At S4, when it is determined that a present position candidate corresponding to a normal run state (also referred to as a normal run candidate) is present among the several present position candidates (S4: YES), the processing proceeds to S6. In contrast, when it is not determined that any normal run candidate is present among the several present position candidates (S4: NO), the processing proceeds to S5.

At S5, it is determined that the subject vehicle is in the reverse run, and the detection result indicating the reverse run state is outputted, then ending the present process. Further, at S5, based on the matching accuracy calculated by the map matching processor 53, the information on the reverse run candidate having the highest matching accuracy may be transmitted to the map matching processor 53 among the reverse run candidates, if present, thereby specifying the position of the reverse run candidate as a position which is displayed as the vehicle position on a map.

At S6, it is determined whether the collision buffer object is detected in the image recognition by the image recognition processor 54. The determination may be made based on the detection result in the image recognition, which uses the capture image data of the vehicle front images captured in a predetermined duration, for instance, starting from the start of the present process among the capture image data of the vehicle front images presently recorded in the memory of the image recognition processor 54. The predetermined duration may be designated as needed.

This configuration can decrease the data volume of the capture image data serving as the detection target for the collision buffer object by the image recognition, thereby reducing the processing load of the image recognition. In addition, the distance range in which to determine whether the collision buffer object is detected can be narrowed down to the distance range which is traveled for the above predetermined duration. This can disregard a collision buffer object that was detected during the normal run in the position traced back too much.

Alternatively, the determination as to whether to detect a collision buffer object may be made based on the detection result in the image recognition, which uses the capture image data of the vehicle front images captured for a predetermined travel distance traced back from the present position among the capture image data of the vehicle front images presently recorded in the memory of the image recognition processor 54. The predetermined travel distance may be designated as needed.

The travel distance may be detected based on the detection signal of the wheel speed sensor 34. The wheel speed sensor 34 may be referred to as a distance detection device or means. In addition, the following example may be presented as the method of executing an image recognition by specifying the capture image data of the vehicle front images captured for a distance range traced back for a predetermined travel distance. That is, after the time necessary to travel a predetermined distance based on an average speed, an image recognition may be made using the capture image data of the vehicle front images for a distance range corresponding to the calculated time.

This configuration can also decrease the data volume of the capture image data serving as the detection target for the collision buffer object by the image recognition, thereby reducing the processing load of the image recognition. In addition, the distance range in which to determine whether the collision buffer object is detected can be narrowed down to the distance range which is traveled for the above predetermined travel distance. This can disregard a collision buffer object that was detected during the normal run in the position traced back too much.

When it is determined that the collision buffer object is detected (S6: YES), the processing proceeds to S7. When it is not determined that the collision buffer object is detected (S6: NO), the processing proceeds to S9.

At S7, based on the node data such as the node coordinates or node classes in the map data inputted from the map data acquisition processor 52, it is determined whether there is a branch point of a highway within a predetermined distance from each present position candidate on the road or on-map road where each present position candidate is located. The predetermined distance may be designated as needed. When it is determined that there is a branch point (S7: YES), the processing process to S9. In contrast, when it is not determined that there is a branch point (S7: NO), the processing proceeds to S8.

At S8, it is determined that the subject vehicle is in the reverse run, and the detection result indicating the reverse run state is outputted, then ending the present process. Further, at S8, based on the matching accuracy calculated by the map matching processor 53, the information on the reverse run candidate having the highest matching accuracy may be transmitted to the map matching processor 53 among the reverse run candidates, if present, thereby specifying the position of the reverse run candidate as a position which is displayed as the vehicle position on a map.

At S9, it is determined that the subject vehicle is in the normal run, and the detection result indicating the normal run state is outputted, then ending the present process. Further, at S9, based on the matching accuracy calculated by the map matching processor 53, the information on the normal run candidate having the highest matching accuracy may be transmitted to the map matching processor 53 among the normal run candidates, if present, thereby specifying the position of the normal run candidate as a position which is displayed as the vehicle position on a map.

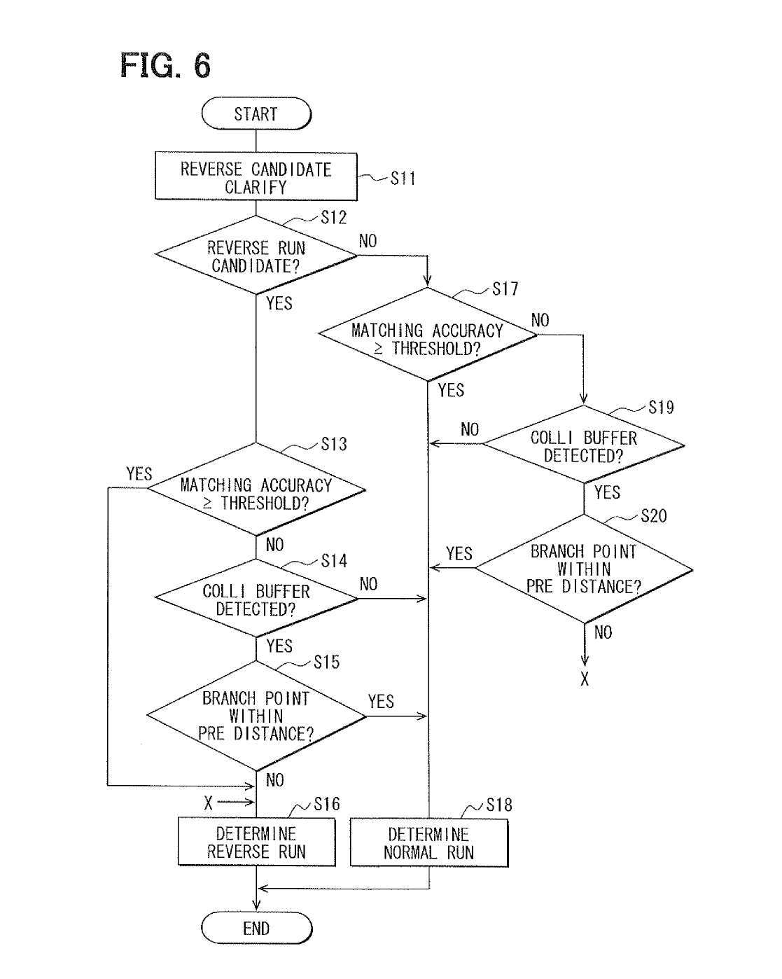

Next, with reference to FIG. 6, in the case that the map matching processor 53 extracts a single present position candidate, the process relevant to the determination as to whether the subject vehicle is in the reverse run in the reverse run detection processor 55 will be explained. It is noted that the present process is started when the present position candidate extracted by the map matching processor 53 is inputted into the reverse run detection processor 55.

At S11, a reverse run candidate clarification process is made with respect to the inputted present position candidate. The processing then proceeds to S12. When it is determined that it is a reverse run candidate (S12: YES), the processing proceeds to S13. When it is not determined that it is a reverse run candidate (S12: NO), the processing proceeds to S17.

At S13, based on the map matching accuracy calculated by the map matching processor 53, it is determined whether the matching accuracy of a road where the reverse run candidate is located is greater than a predetermined threshold value. The predetermined threshold value is designated as needed. It is designated to be higher than the map matching accuracy serving as a basis in the case of extracting a present position candidate.

When it is determined that the map matching accuracy is equal to or greater than the predetermined threshold value (S13: YES), the processing proceeds to S16. When it is not determined that the map matching accuracy is equal to or greater than the predetermined threshold value (S13: NO), the processing proceeds to S14.

At S14, like S6, it is determined whether the collision buffer object is detected in the image recognition by the image recognition processor 54. When it is determined that the collision buffer object is detected (S14: YES), the processing proceeds to S15. When it is not determined that the collision buffer object is detected (S14: NO), the processing proceeds to S18.

At S15, like at S7, it is determined whether there is a branch point of a highway within a predetermined distance from the reverse run candidate on the road or an-map road where the reverse run candidate is located. When it is determined that there is a branch point (S15: YES), the processing proceeds to S18. In contrast, when it is not determined that there is a branch point (S15: NO), the processing proceeds to S16.

At S16, it is determined that the subject vehicle is in the reverse run state, and the detection result indicating the reverse run state is outputted, then ending the present process. In addition, there is a case that as the result of the processing at S16, it is determined that there is no present position candidate that is specified as a position displayed as a vehicle position. In such a case, a message which indicates that specifying the present position of the subject vehicle is impossible is displayed by the display device 39 or sounded by the sound output device 40.

At S17, like at S13, it is determined whether the matching accuracy of the road where the normal run candidate is located is equal to or greater than a predetermined threshold value. When it is determined that the map matching accuracy is equal to or greater than the predetermined threshold value (S17: YES), the processing proceeds to S18. When it is not determined that the map matching accuracy is equal to or greater than the predetermined threshold value (S17: NO), the processing proceeds to S19.

At S18, it is determined that the subject vehicle is in the normal run, and the detection result indicating the normal run state is outputted, then ending the present process. In addition, there is a case that as the result of the processing at S18, it is determined that there is no present position candidate that is specified as a position displayed as a vehicle position. In such a case, a message which indicates that specifying the present position of the subject vehicle is impossible is displayed by the display device 39 or sounded by the sound output device 40.

At S19, like S6, it is determined whether the collision buffer object is detected in the image recognition by the image recognition processor 54. When it is determined that the collision buffer object is detected (S19: YES), the processing proceeds to S20. When it is not determined that the collision buffer object is detected (S19: NO), the processing proceeds to S18.

At S20, like at S7, it is determined whether there is a branch point of a highway within a predetermined distance from the normal run candidate on the road where the normal run candidate is located. When it is determined that there is a branch point (S20: YES), the processing proceeds to S18. In contrast, when it is not determined that there is a branch point (S20: NO), the processing proceeds to S16.

It is noted that when only one present position candidate is extracted by the map matching processor 53, whether the subject vehicle is in a reverse run state may be determined according to the result of the reverse run candidate clarification process. That is, when it is determined that the present position candidate is a reverse run candidate in the reverse run candidate clarification process, it is determined that the subject vehicle is in the reverse run state. That is, when it is determined that the present position candidate is a normal run candidate in the reverse run candidate clarification process, it may be determined that the subject vehicle is not in the reverse run state.

In addition, even when all the present position candidates correspond to the reverse run state, as at S5, or even when all the present position candidates correspond to the normal run state, as at S3, whether the subject vehicle is in the reverse run state may be determined based on the matching accuracy of the road where the present position candidate is located and the detection result of the collision buffer object in the image recognition, like in the flowchart in FIG. 6.

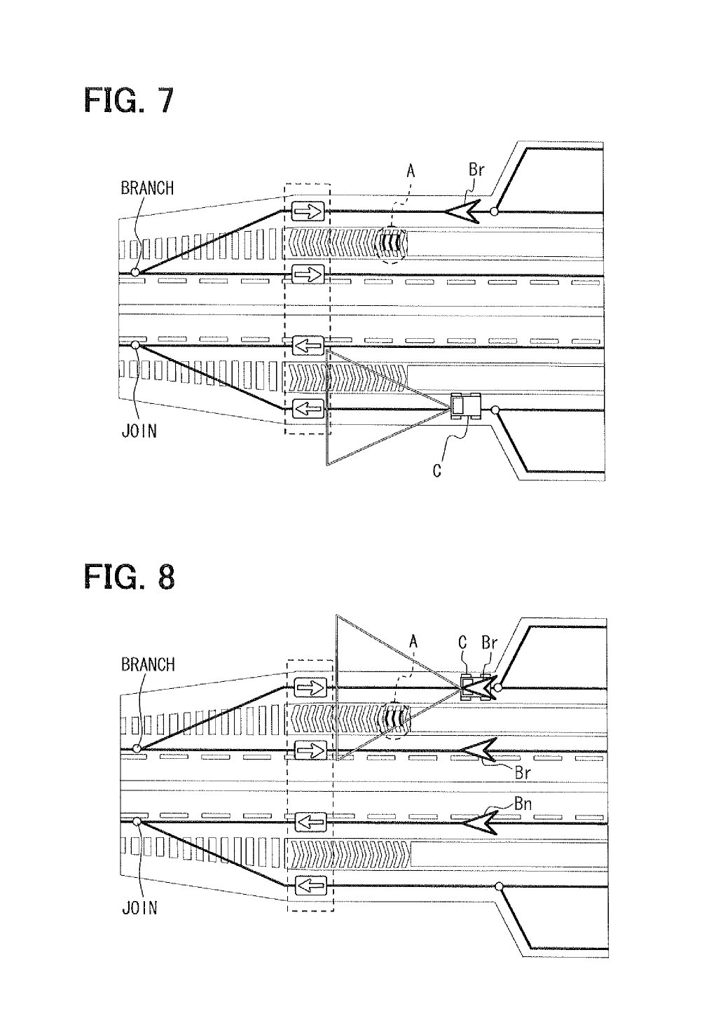

The following explains an operation of the present embodiment specifically using FIG. 7 to FIG. 9. FIGS. 7 to 9 are diagrams illustrating operations in the configuration of the present embodiment. In the drawings, “BRANCH” means a branch point in a highway at which an exit road (i.e., a branch road) starts departing from a main road of the highway; “JOIN” means a join point at which an entrance road (i.e., a join road from an area outside of the highway) ends joining into a main road of the highway. Further, A indicates a collision buffer object; Bn indicates a present position candidate in a normal run state; Br indicates a present position candidate in a reverse run state; C indicates an actual present position of the subject vehicle; D indicates one branch point of a determination target; and an arrow surrounded by a rectangular broken line frame indicates a one-direction traffic attribute.

FIG. 7 illustrates the case that there is only one reverse run candidate Br as a present position candidate of the subject vehicle, but the subject vehicle is actually in a present position C corresponding to a normal run state. In this case, the image recognition by the image recognition processor 54 does not detect any collision buffer object peculiar to a branch point. Thus, it is determined that the subject vehicle is not in a reverse run state, thereby preventing incorrect determination of the reverse run.

In addition, FIG. 8 illustrates the case that although the subject vehicle is at a present position C in a reverse run state, there are existing simultaneously a reverse run candidate Br and a normal run candidate Bn as the present position candidates, providing a difficult situation to determine that the subject vehicle is in a reverse run state. In this case, the image recognition by the image recognition processor 54 detects a collision buffer object A peculiar to a branch point. Thus, it is determined that the subject vehicle is in a reverse run state, thereby enabling the more accurate determination of a reverse run state in a highway.

Thus, under the configuration of the present embodiment, the image recognition in the image recognition processor 54 is adopted to detect a collision buffer object peculiar to a branch point. What the image recognition or front camera 1 is primarily required in the present embodiment is only to detect a collision buffer object in a heading direction of the subject vehicle. The image recognition need not specify or differentiate either a normal run case where it is visible when the subject vehicle is approaching in a normal run state or a reverse run case where it is visible when the subject vehicle is approaching in a reverse state, providing an advantage in simplifying a configuration.

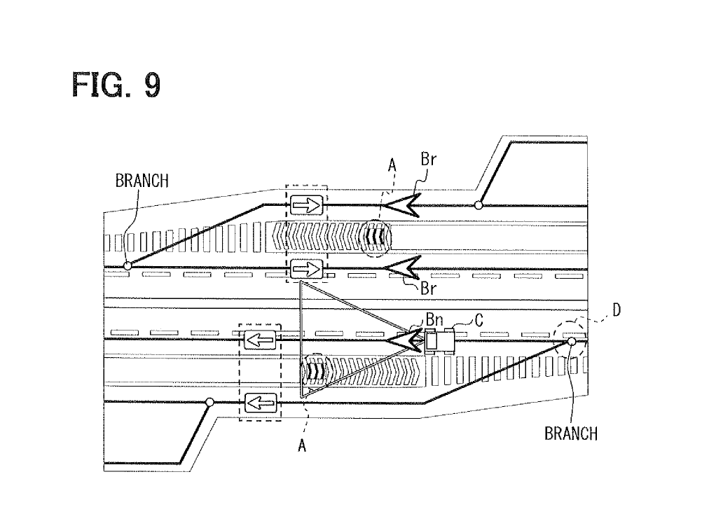

Furthermore, FIG. 9 illustrates the case where there are a reverse run candidate Br and a normal run candidate Bn as the present position candidates, and the subject vehicle is actually at a present position C in a normal run state while the image recognition by the image recognition processor 54 detects a collision buffer object A peculiar to the branch point D. Under such a case, when it is determined that the branch point D of a highway exists within a predetermined distance from the present position candidate Bn, it is determined that the subject vehicle is not in a reverse run state. Based on the detection of the collision buffer object A peculiar to the branch point D when passing by the branch point D in the normal run state, the event that mistakenly determines that the subject vehicle is in a reverse run state can be prevented, thereby enabling the more accurate determination of a reverse run state in a highway.

Further, under the present embodiment, the reverse run state is determined based on the present position candidate before specifying a position which is displayed as a vehicle position and the detection result of the collision buffer object. As compared with the case where the reverse run state is determined after specifying the position that is displayed as a vehicle position, the warning of the reverse run state can be made promptly.

Furthermore, under the present embodiment, suppose the case where while only one present position candidate is determined to correspond to a reverse run state, the present position candidate's matching accuracy is less than a predetermined threshold value and the accuracy of the determination of the reverse run candidate clarification process may be low. In such a case, based on the detection of the structural object peculiar to a branch point, the incorrect determination relative to the reverse run state can be prevented.

Further, in the present embodiment, a collision buffer object is detected as a structural object peculiar to a branch point in the image recognition. There is no need to be limited to the above. Any structural object peculiar to a branch point can be detected in the image recognition.

In the present embodiment, a collision buffer object is detected and the determination is then made as to whether a branch point is within the predetermined distance, There is no need to be limited to the above. For example, after specifying a collision buffer object as being in either a reverse run or a normal run, the collision buffer object may be detected in the image recognition. In this case, a normal run specification dictionary and a reverse run specification dictionary may be used for the image recognition as the dictionary for image recognition. The normal run specification dictionary is generated by learning based on images of the collision buffer objects in a normal run state (e.g., an image of a collision buffer object captured from a front side of the collision buffer object. The reverse run specification dictionary is generated by learning based on images of the collision buffer objects in a reverse run state (e.g., an image of a collision buffer object captured from an oblique back side of the collision buffer object.

The configuration using the two dictionaries may be added to the point after it is determined that there is a branch point within a predetermined distance (S7: YES in FIG. 5, or S15: YES in FIG. 6) based on the detection of the collision buffer object (S6 in FIG. 5, or S14 in FIG. 6). Further, those may be used as a reinforcement of the determination of the detection of the collision buffer object at S6 in FIG. 5, and at S14 in FIG. 6 while omitting the determination as to whether there is a branch point within a predetermined distance (S7 in FIGS. 5 and S15 in FIG. 6)

Then, the image recognition obtains a result by specifying the collision buffer object as being in either a reverse run or a normal run. Based on the result, when the normal run side of the collision buffer object is detected, the determination of the normal run state may be reinforced or determined. When the reverse run side of the collision buffer object is detected, the determination of the reverse run state may be reinforced or determined. According to this configuration, more accurate determination of either a normal run state or a reverse run state can be made.

For instance, suppose the case of a service area or parking area where an area entrance road (also referred to a highway exit road) and an area exit road (also referred to a highway entrance road) are close to each other. Here, further suppose the case that the subject vehicle is in a reverse run state to reversely run the area entrance road (i.e., the highway exit road) to the highway. In this case, it is determined that the branch point of the highway exists within a predetermined distance from the present position candidate. In this case, the subject vehicle is actually in a reverse run state. Based on the detection of the collision buffer object as being in a reverse run side, the reverse run state can be determined accurately.

In addition, suppose the case that the matching accuracy of the present position candidate is less than a predetermined threshold value and the accuracy of the reverse run candidate clarification process is low. Even in such a case, the determination of either a reverse run state or a normal run state can be at least reinforced using the detection result of specifying the collision buffer object as being a reverse run side or a normal run side.

The above mentioned normal run specification dictionary and the reverse run specification dictionary may be accumulated in a center server separated from or outside of the subject vehicle. The navigation apparatus 3 may acquire those dictionaries from the center server using a communication device such as a data communication module (DCM) and uses the dictionaries for image recognition in the image recognition processor 54.

More desirably, the center server may accumulate position information such as coordinates of branch points of highways and the normal run specification dictionary and the reverse run specification dictionary with respect to all the collision buffer objects of inbound lanes and outbound lanes in association with each other. When the subject vehicle approaches a branch point, the navigation apparatus 3 may acquire the normal run specification dictionary and the reverse run specification dictionary corresponding to the branch point via the data communication module from the center server. By using the acquired dictionaries, the image recognition may be made with respect to the images captured by the front camera 1.

Thus, the normal run specification dictionary and the reverse run specification dictionary are prepared for all the collision buffer objects at the branches in the highways in all the inbound or outbound lanes; thus, the specification of either the normal run side or the reverse run side can be made accurately. The determination of either the normal run state or reverse run state can be made more accurately.

In addition, as shown in FIG. 9, there is a case that different entrances to service areas or parking areas are close to each other. The position corresponding to those entrances may be stored; a reverse run determination may be previously prohibited in this position. Thus, a reverse run determination may be prohibited in a predetermined condition.

It will be obvious to those skilled in the art that various changes may be made in the above-described embodiments of the present invention. However, the scope of the present invention should be determined by the following claims.

What is claimed:

1. A vehicular driving assistance apparatus mounted in a vehicle, the apparatus comprising:
a position and direction detection device to detect a present position and a heading direction of the vehicle serially;
a map data storage device to store map data including road data containing data on one-way traffic attribute;
a candidate extraction section to extract a present position candidate of the vehicle on an on-map road by matching a travel track of the vehicle on the on-map road based on a present position and a heading direction of the vehicle detected by the position and direction detection device and the map data stored in the map data storage device;
a position specification section to specify a present position of the vehicle on an on-map road based on a present position candidate extracted by the candidate extraction section;
an image capture device to capture serially an image in a heading direction of the vehicle;
an image recognition section to detect from an image captured by the image capture device with image recognition a structural object peculiar to a branch point that is contained together with a joint point in a highway;
a reverse run candidate clarification section to clarify whether a present position candidate of the vehicle is a revere run candidate that corresponds to a reverse run state of the vehicle or a normal run candidate that does not correspond to a reverse run state of the vehicle based on (i) a present position candidate extracted by the candidate extraction section, (ii) a heading direction of the vehicle detected by the position and direction detection device, and (iii) the road data containing the data on one-way traffic attribute; and
a reverse run determination section to determine whether the vehicle is in a reverse run state based on a clarification result by the reverse run candidate clarification section and a detection result by the image recognition section in cases that the candidate extraction section extracts a plurality of present position candidates,
the reverse run determination section determining that the vehicle is in the reverse run state in cases that
(i) a reverse run candidate of the vehicle that is clarified to correspond to the reverse run state of the vehicle and a normal run candidate of the vehicle clarified not to correspond to the reverse run state of the vehicle coexist within the plurality of present position candidates extracted by the candidate extraction section, and
(ii) the structural object peculiar to the branch point is detected by the image recognition section, the reverse run determination section not determining that the vehicle is in the reverse run state in cases that
(i) the reverse run candidate and the normal run candidate coexist within the plurality of present position candidates extracted by the candidate extraction section, and
(ii) the structural object peculiar to the branch point is not detected by the image recognition section.

2. The vehicular driving assistance apparatus according to claim 1, wherein:
the road data stored in the map data storage device further contains data on branch points of highways;
the reverse run determination section determines whether a branch point exists within a predetermined distance from each of the plurality of present position candidates on the on-map road where the each of the plurality of present position candidate exists in cases that (i) the reverse run candidate and the normal run candidate coexist within the plurality of present position candidates extracted by the candidate extraction section, and (ii) the structural object peculiar to the branch point is not detected by the image recognition section;
the reverse run determination section determines that the vehicle is in the reverse run state when determining that the branch point does not exist within the predetermined distance from the each of the plurality of present position candidates; and
the reverse run determination section does not determine that the vehicle is in the reverse run state when determining that the branch point exists within the predetermined distance from the each of the plurality of present position candidates.

3. The vehicular driving assistance apparatus according to claim 1, wherein:
the reverse run determination section executes a determination as to whether or not the structural object peculiar to the branch point is detected by the image recognition section for a predetermined duration back in time;
the structural object is determined to be detected by the image recognition section when the executed determination is made affirmatively; and
the structural object is determined to be not detected by the image recognition section when the executed determination is made negatively.

4. The vehicular driving assistance apparatus according to claim 1, further comprising:
a distance detection device to detect a run distance of the vehicle,
wherein:
the reverse run determination section executes a determination as to whether or not the structural object peculiar to the branch point is detected by the image recognition section for a distance range traced back by a predetermined run distance based on the run distance of the vehicle detected by the distance detection device;
the structural object is determined to be detected by the image recognition section when the executed determination is made affirmatively; and
the structural object is determined to be detected by the image recognition section when the executed determination is made affirmatively.

5. The vehicular driving assistance apparatus according to claim 1, wherein
the reverse run determination section does not determine that the vehicle is in the reverse run state when the structural object peculiar to the branch point is not detected by the image recognition section
even in cases that the reverse run candidate clarification section clarifies that the vehicle is in the reverse run state with respect to all the plurality of present position candidates extracted by the candidate extraction section.

6. The vehicular driving assistance apparatus according to claim 1, wherein
the reverse run determination section does not determine that the vehicle is in the reverse run state when the reverse run candidate clarification section clarifies, with respect to all the plurality of present position candidates, that the vehicle is not in the reverse run state.

7. The vehicular driving assistance apparatus according to claim 1, further comprising:
a matching accuracy calculation section to calculate a matching accuracy that is an index indicating an accuracy of matching by the candidate extraction section,
wherein:
the reverse run determination section determines whether the vehicle is in the reverse run state based on a calculation result by the matching accuracy calculation section as well as a determination result by the reverse run candidate clarification section and a detection result by the image recognition section; and
even in cases that (i) only a single present position candidate is extracted by the candidate extraction section, and (ii) the reverse run candidate clarification section clarifies that the vehicle is in the reverse run state with respect to the single present position candidate,
the reverse run determination section does not determine that the vehicle is in the reverse run state when (i) the structural object peculiar to the branch point is not detected by the image recognition section, and (ii) a matching accuracy calculated by the matching accuracy calculation section is equal to or less than a predetermined threshold value.

8. The vehicular driving assistance apparatus according to claim 1, wherein
the structural object peculiar to the branch point is a collision buffer object arranged in a branch point on a highway, the branch point at which a branch road branches from the highway.

9. The vehicular driving assistance apparatus according to claim 1, wherein
the image capture device captures an image of a normal run side and a reverse run side of the structural object peculiar to the branch point,
the normal run side being captured when the vehicle approaches the structural object in the normal run state,
the reverse run side being captured when the vehicle approaches the structural object in the reverse run state; and
the structural object peculiar to the branch point is detected by the image recognition section using the reverse run side from among the reverse run side and the normal run side.
